(19) United States
(12) Patent Application Publication
(10) Pub. No.: US 2012/0038118 A1
(43) Pub. Date: Feb. 16, 2012

(54) Seal Device For Sealing Connector

(76) Inventor: Hongjun Yin, Shanghai (CN)

(21) Appl. No.: 13/207,181

(22) Filed: Aug. 10, 2011

(30) Foreign Application Priority Data
Aug. 10, 2010 (CN) 201020289608.8

(51) Int. Cl. F16J 15/02

(52) U.S. Cl. 277/630

(57) ABSTRACT

A seal device for sealing a connector having a first casing and a second casing. The first casing includes a first engagement edge and a first connection portion that extends from the first engagement edge. The second casing includes a second engagement edge and a second connection portion that extends from the second engagement edge. The second casing and the first casing engage each other when closed along the first and second engagement edges to form a connector receiving inner chamber. The first connection portion and the second connection portion detachably connect with each other.

### CROSS-REFERENCE TO RELATED APPLICATIONS

This application claims the benefit of the filing date under 35 U.S.C. §119(a)-(d) Chinese Patent Application No. 201020289608.8 filed on Aug. 10, 2010.

### FIELD OF THE INVENTION

The invention relates to a seal device, and in particular, to a seal device applied to a connector used in a communication network.

### BACKGROUND

Cable connectors, feeder connectors, optical fiber connectors or DIN (Deutsche Industrie Norm) connectors all require waterproof sealing, and in some cases, it is required to meet the highest sealing standard, i.e., IP68. IP level stands for ingress protection level, and different IP levels indicate different levels of the ability of an instrument in preventing impurity ingress. The IP level system is established by International Electrotechnical Commission, IEC) as an IEC standard 529 to provide instructions regarding the protection of an instrument. One IP level includes two numbers, each indicating one kind of characteristic. A specific IP level represents a degree that ingress of impurities, such as moisture and dust can be prevented. The larger the number is, the better a protection performance is represented. The first IP number relates to particulate ingress, that is, it indicates a protection degree against solid impurities. For example, level 5 indicates the product can protect against the ingress of dust and other foreign substance with a diameter bigger than 1.0 mm. The highest level for the first IP number is 6, which means dust ingress is completely prevented.

The second IP number represents the moisture-proof level, for example level 4 indicates that ingress of water from any direction can be prevented. The highest level for the second number is 8, which indicates that protection is against long-term water immersion.

Hence, IP68 represents the highest protection level in the IP level system

However, many seal devices in the known art do not meet the requirements under IP68. Specifically, in the case that the seal devices have been used for a long term, connection circuits tend to be affected by moisture and thus the connection performance of the connection circuits is degraded. Therefore, existing known seal devices cannot meet the sealing requirement for products being used outdoor for a long time.

In the market, the known seal device reaching the level of IP68 includes two separate members, one is a sealing body, the other is a hook, a spring or a screw separated from the sealing body. In the sealing process, a connector to be sealed is first wrapped by a sealing body, and then the sealing body is fixed to a connector by a hook, a spring or a screw to seal the connector. The disadvantages of the above seal device lie in that: because the seal device includes two separate members, the operation thereof is inconvenient, and the installation efficiency thereof is low. In addition, if the screw is small, it tends to be lost during disassembly and assembly of the seal device. Further, manufacturing the attachment of the seal device, such as the hook, the spring or the screw, needs additional molding and a separate machine, which results in a higher manufacturing cost.

### SUMMARY

The present invention has been made, among others, to overcome or alleviate at least one aspect of the above mentioned disadvantages.

Accordingly, an object of present invention, among others, is to provide a seal device for sealing a connector, the seal device provides a protection level of IP68. Moreover, the cost for manufacturing the seal device is low, and the operation thereof is convenient.

According to invention, a seal device for sealing a connector includes a first casing and a second casing. The first casing includes a first engagement edge and a first connection portion that extends from the first engagement edge. The second casing includes a second engagement edge and a second connection portion that extends from the second engagement edge. The second casing and the first casing engage each other when closed along the first and second engagement edges to form a connector receiving inner chamber. The first connection portion and the second connection portion detachably connect with each other.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a seal device according to the invention, in which the seal device is open;

FIG. 2 is a side view of the seal device for sealing according to the invention, in which the seal device is open;

FIG. 3 is a top view of the seal device according to the invention;

FIG. 4 is a side view of the seal device according to the invention, in which the seal device is closed ; and

FIG. 5 is an exploded view of a seal device according to the invention used for sealing a connector.

### DETAILED DESCRIPTION OF THE EMBODIMENT(S)

Embodiments of the present invention will be described hereinafter in detail with reference to the attached drawings, wherein the like reference numerals refer to the like elements throughout the specification. These embodiments should not be construed as being limited to the embodiment set forth herein, rather for illustrative purpose.

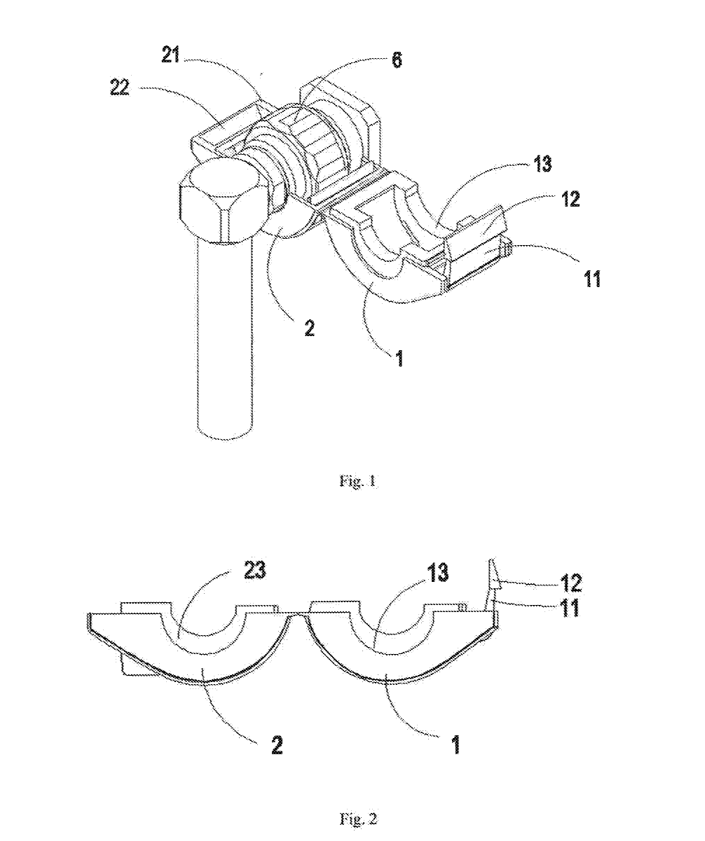

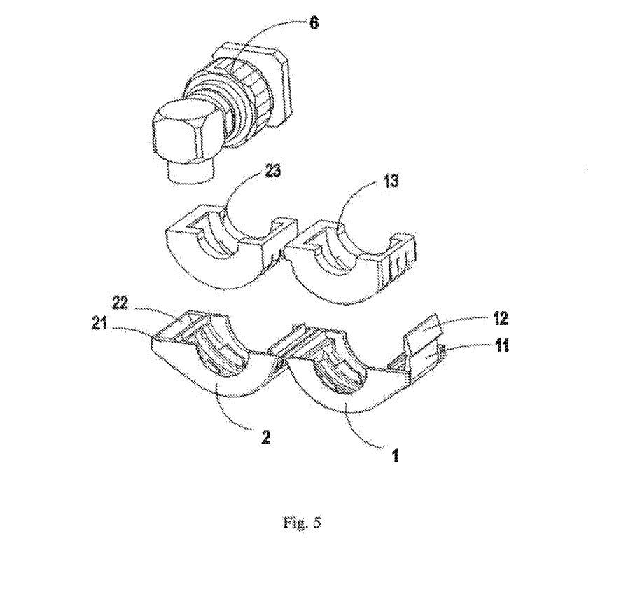

Referring to FIGS. 1-5, a seal device for sealing a connector 6 for a cable, a feeder, an optical fiber or a DIN connector and the like is shown. The seal device includes a first casing 1 having a first engagement edge and a second casing 2 having a second engagement edge. The second casing 2 and the first casing 1 engage each other at the first and second engagement edges to form an inner chamber for receiving the connector 6 of spliced cables. The first casing 1 further includes a first connection portion 11 extending outwardly from the first engagement edge, and the second casing 2 further includes a second connection portion 21 extending outwardly from the second engagement edge. The first and second connection portions 11 and 21 being detachably connected so that the first casing 1 and the second casing 2 seal the connector 6 in the inner chamber.

Please be noted that though in the exemplary embodiments the cables are spliced, and those skilled in the art will appreciate that the invention can also be applied to the connector for splicing optical fibers, feeders or a DIN connector and the like.

In another embodiment of the invention, the first connection portion 11 and the second connection portion 21 are detachably connected, therefore, the first connection portion 11 and the second connection portion 21 may be disconnected or disengaged later by a corresponding operation without breaking structures of first and second connection portions 11 and 21.

According to an exemplary embodiment of the invention, the first connection portion 11 and the second connection portion 21 are detachably connected in a snap-fit manner. Further, the first connection portion 11 includes a male member extending perpendicularly from the first engagement edge, and the second connection portion 21 includes a female member extending perpendicularly from the second engagement edge, wherein the male member is insertable into the female member and be detachably fastened in the female member in a snap-fit manner.

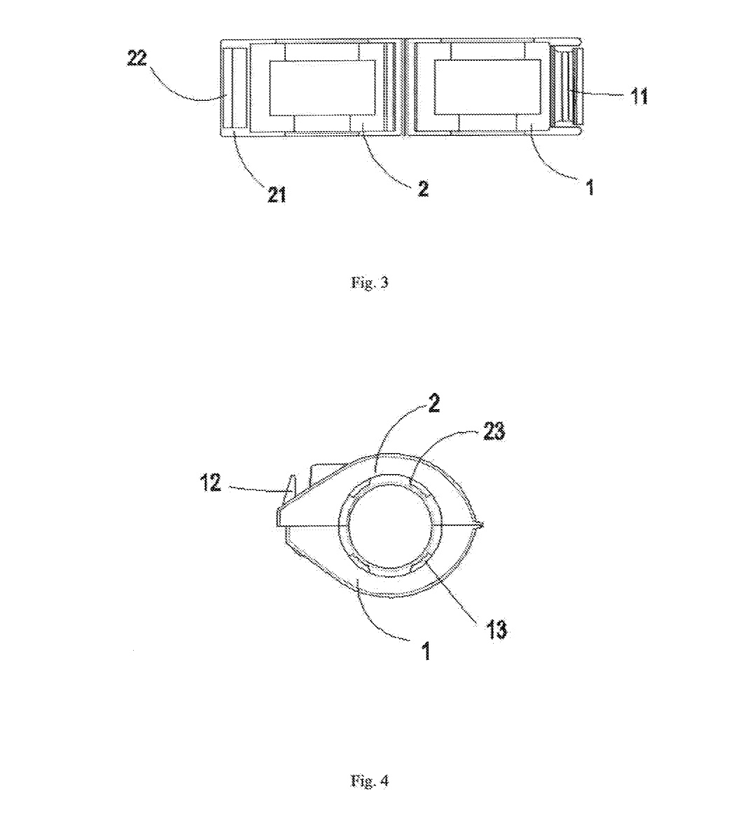

In a further exemplary embodiment of the invention, the female member is a frame having a receiving passageway 22 therein, the male member has a little elasticity, and an end of the male member is provided with a fixing retainer 12. When the male member is inserted into the frame, the fixing retainer 12 holds the male member in the frame. The fixing retainer 12 has a stop surface substantially perpendicular to an inserting direction of the male member. As shown in FIG. 2, the fixing retainer 12 has a cross section substantially of a right-angled triangle shape. Thus, the fixing retainer 12 is a triangular protrusion projecting outwards when viewed from a side. In this case, when the male member of the first connection portion 11 is inserted into the receiving passageway 22 in the frame, the fixing retainer 12 having a triangular protruding shape first passes through the frame, and an outer inclined plane thereof guides the male member into the receiving passageway 22 in the frame with the male member being pressed inwards by an inner wall of the receiving passageway 22. When the fixing retainer 12 has completely passed through the frame, an elastic force of the male member makes the fixing retainer 12 spring outwards and thus secured to the frame. Therefore, the male member is retained within the frame. In order to open the first casing 1 and the second casing 2, the male member extending out of the frame (see FIG. 4) may be pressed so that the fixing retainer 12 having a triangular protruding shape disengages with a lower edge of the frame, and thus the first casing 1 is released from the second casing 2, in this case, the first and second casings 1 and 2 may be opened.

According to an exemplary embodiment of the invention, the first and second casings 1 and 2 are made of, for example, engineering plastic material. A first side of the first casing 1 and a first side of the second casing 2 are integrally formed, and a connection part between the first and second casings 1 and 2 at the first sides may be thinner than other parts of the first and second casings 1 and 2, thus, the first and second casings 1 and 2 may be turned with respect to the first side. The first engagement edge and the second engagement edge are formed respectively at second sides of the first and second casings 1 and 2 opposite to the first sides.

Further, each of the first casing 1 and the second casing 2 has a substantially vaulted profile and forms therein a cavity; each of the first casing 1 and the second casing 2 forms two arc recesses respectively at a third side and a fourth side perpendicular to the first and second sides, wherein when the first casing 1 and the second casing 2 are closed. The cavities of the first and second casings 1 and 2 are engaged together to form the inner chamber for receiving the connector 6, and the corresponding arc recesses are engaged together to form substantially O-shaped openings for introducing spliced cables, the O-shaped openings being communicated with the inner chamber.

During sealing, the connector 6 is positioned in advance in the cavity of the second casing 2, then the first casing 1 and the second casing 2 are connected, and two ends of the connector 6 (or two spliced cables) pass through the openings formed by paired arc recesses at the third and fourth sides of the sealing device. First arc elastic sealing pieces 13 and second arc elastic sealing pieces 23 are positioned respectively at the arc recesses of the first and second casings 1 and 2, and specifically, for example, are positioned at edge portions of the cavities of the first and second casings 1 and 2. Both the first arc elastic sealing pieces 13 and second arc elastic sealing pieces 23 protrude above the arc recesses positioned at both sides of the first and second casings 1 and 2. In this case, during sealing, the elastic sealing pieces may be compressed to press the cables (or two ends of the connector 6) passing through the openings to seal the connector 6. The first and second arc elastic sealing pieces 13 and 23 may be made from elastic material, such as gel or rubber.

The male member of the first connection portion 11 extends downwards and is perpendicular to a bottom surface of the first casing 1, and the female member used as the frame extends laterally and in parallel with the bottom surface of the second casing 2. For sealing, the male member is inserted perpendicularly into the receiving passageway 22 in the female member and is detachably engaged within the receiving passageway 22 so that the connector 6 is held in a sealed state.

The engineering plastic used for the casings of the invention may include PP, PBT, PC, PAT, PA66 or the like..

The sealing device according to the invention may be integrally formed, that is, the seal device is a one-piece member rather than a two-piece member. Thus, additional molding is not needed, no additional details are used for fastening, and therefore the manufacturing process and operation thereof are simplified.

Next, the operation of the sealing device according to the invention will be described as follows:

First, the first casing 1 and the second casing 2 are opened with respect to the thinner connection part, then the connector 6 to be sealed is positioned in the cavity of the second casing 2, and two ends (or two spliced cables) of the connector 6 are fit in the arc recesses at the third and fourth sides of the second casing 2.

Second, the first casing 1 and the second casing 2 are folded along the thinner connection part and closed, and the male member is inserted into the female member. When the fixing retainer 12 enters the receiving passageway 22 in the frame, the fixing retainer 12 springs outwards such that the male member is fixed in the receiving passageway 22 in the frame. At the same time, the first and second arc elastic sealing pieces 13 and 23 are pressed against the two ends of the connector 6. Thus, the connector 6 may be sealed for long periods.

The first side of the first casing 1 and the first side of the second casing 2 may be connected using other turnable mechanisms, such as a hinge, pivot, pin or the like.

In another embodiment of the invention, the first casing 1 and the second casing 2 may be separated, for example, both the first and second sides of the first and second casings 1 and 2 are respectively positioned with the first connection portion 11 and the second connection portion 12. During sealing, the first connection portions 11 and the corresponding second connection portions 12 at the first and second sides of the first and second casings 1 and 2 are connected and secured together respectively. In this case, the first casing 1 and the second casing 2 are closed and sealed.

In the above mentioned exemplary embodiments of the invention, the first connection portion 11 includes the male member, and the second connection portion 12 includes the female member. Thus, the first and second casings 1 and 2 are connected together in a snap-fit manner. However, the present invention is not limited to this. Those skilled in the art will appreciate that the first and second casings 1 and 2 may be releaseably engaged with each other in using other snap-fit mechanism. For example, in an alternative exemplary embodiment, the first connection portion 11 includes an extending piece extending perpendicularly from the first engagement edge. The extending piece is provided with a protrusion extending inwards. The second connection portion 21 includes a groove extending inwards from an outer side of the second engagement edge. When the first and second casings 1 and 2 are closed, the protrusion is engaged within the groove in a snap-fit manner so that the first and second casings 1 and 2 are detachably engaged with each other. Further, in the above alternative embodiment, the second connection portion 21 includes a protrusion extending outwards from an outer side of the second engagement edge, and the protrusion of the second connection portion 21, the protrusion of the first connection portion 11 form an interference fit so that the first and second casings 1 and 2 are detachably engaged.

Although several exemplary embodiments have been shown and described, it would be appreciated by those skilled in the art that various changes or modifications may be made in these embodiments without departing from the principles and spirit of the disclosure, the scope of which is defined in the appended claims and their equivalents.

What is claimed is:

1. A seal device for sealing a connector, comprising:
a first casing having a first engagement edge and a first connection portion extending from the first engagement edge; and
a second casing having a second engagement edge and a second connection portion extending from the second engagement edge, the second casing and the first casing engage each other along the first and second engagement edges forming a connector receiving inner chamber and the first connection portion and the second connection portion detachably connect with each other.

2. The seal device according to claim 1, wherein the first connection portion and the second connection portion connect through a snap-fit mechanism.

3. The seal device according to claim 2, wherein the first connection portion includes a male member.

4. The seal device according to claim 3, wherein the second connection portion includes a female member.

5. The seal device according to claim 4, wherein the female member receives the male member that detachably fastens with the female member.

6. The seal device according to claim 5, wherein the female member is a frame having a receiving passageway therein.

7. The seal device according to claim 6, wherein the male member includes a fixing retainer positioned on an end, the fixing retainer secures the male member when positioned in the receiving passageway.

8. The seal device according to claim 7, wherein the fixing retainer includes a stop surface substantially perpendicular to an inserting direction of the male member.

9. The seal device according to claim 8, wherein the fixing retainer includes a cross section having a substantially right-angled triangle shape.

10. The seal device according to claim 8, wherein the male member is elastic.

11. The seal device according to claim 2, wherein the first connection portion includes an extending piece having a protrusion extending inwards and perpendicular from the first engagement edge.

12. The seal device according to claim 11, wherein the second connection portion includes a groove extending inwards from an outer side of the second engagement edge.

13. The seal device according to claim 12, wherein the protrusion fits with the groove such that the protrusion is secured within the groove when the first and second casings close.

14. The seal device according to claim 1, wherein a first side of the first casing and a first side of the second casing are integrally formed and rotatable from each other.

15. The seal device according to claim 14, wherein the first engagement edge and the second engagement edge are positioned respectively at second sides of the first and second casings opposite to the first sides.

16. The seal device according to claim 14, wherein the first casing and the second casing have a substantially vaulted profile that forms a pair of cavities respectively therein.

17. The seal device according to claim 16, wherein the first casing and the second casing include a pair of arc recesses respectively at a third side and a fourth side perpendicular to the first and second sides.

18. The seal device according to claim 17, wherein the pair of cavities of the first and second casings close together to form the connector receiving inner chamber.

19. The seal device according to claim 18, wherein the pair of arc recesses close together to form cable receiving O-shaped openings.

20. The seal device according to claim 19, wherein the pair of arc recesses of the first and second casings include arc elastic sealing pieces respectively.

21. The seal device according to claim 18, wherein the first casing and the second casing further include first elastic sealing pieces and second elastic sealing pieces respectively, both the first elastic sealing pieces and the second elastic sealing pieces protrude above the pair of arc recesses positioned at both sides of the first and second casings.
